(19) United States
(12) Patent Application Publication
(10) Pub. No.: US 2011/0274331 A1
(43) Pub. Date: Nov. 10, 2011

(54) MAGNETIC RESONANCE IMAGING METHOD FOR ACHIEVING WATER-FAT SEPARATION

(76) Inventor: De He Weng, Shenzhen (CN)

(21) Appl. No.: 13/097,245

(22) Filed: Apr. 29, 2011

(30) Foreign Application Priority Data
Apr. 30, 2010 (CN) 201010160445.8

(51) Int. Cl. G06K 9/00

(52) U.S. Cl. 382/131

(57) ABSTRACT

A magnetic resonance imaging method for achieving water-fat separation; the method includes utilizing BLADE trajectories to collect the original data of one in-phase image and the original data of two out-of-phase images; reconstructing the in-phase image on the basis of the original data of the in-phase image, and utilizing the original data of the in-phase image to perform phase correction on the original data of the out-of-phase images, and reconstructing the out-of-phase images; and calculating the images of water and fat on the basis of the in-phase image and the out-of-phase images. Since the BLADE trajectory is used to acquire the k-space data, it provides the advantages that the BLADE trajectories are insensitive to the motion and pulsation of a rigid body, reduce the degree of sensitivity to motion artifacts, and also improve the images' signal-to-noise ratio.

### BACKGROUND OF THE INVENTION

1. Field of the Invention

The present invention relates to the technical field of magnetic resonance imaging and, particularly, to a magnetic resonance imaging method for achieving water-fat separation.

2. Description of the Prior Art and Related Subject Matter

In magnetic resonance imaging (MRI), since the hydrogen protons in fat tissues and the hydrogen protons in other tissues in a human body are in different molecular environments, their resonance frequencies are different. After the hydrogen protons in fat tissues and other tissues are simultaneously excited by radio frequency pulses, their relaxation times are also different. By collecting signals at various echo times, fat tissues and non-fat tissues would show different phases and signal strengths.

The Dixon method is a method used in MRI for producing an image of pure water protons, and the basic principle thereof is that by acquiring separately both in-phase and out-of-phase echo signals of protons in water and fat and by performing calculations on the echo signals at the two different phases, they would each produce an image of pure water protons and an image of pure fat protons, thus achieving the object of fat suppression on the image of water protons.

In order to obtain the images of water and fat at the same time, an improved three-point Dixon method has been widely used, and the principle thereof is that by acquiring one in-phase (or out-of-phase) image and two out-of-phase (or in-phase) images at the same time, calculating an additional phase caused by non-uniformity of the magnetic field on the basis of the two out-of-phase (or in-phase) images, performing phase correction on the two out-of-phase (or in-phase) images, then using the two out-of-phase (or in-phase) images together with the in-phase (or out-of-phase) image, the image of water and the image of fat are obtained.

There are many k-space data sampling (data entry) methods in combination with the Dixon method in the art, for example, Cartesian trajectory, radial or spiral trajectory. Among them, Cartesian trajectory refers to the entry of the k-space data according to Cartesian axes and the utilization of a fast Fourier transform (FFT) to produce the image of the coordinate space and then to calculate the images of water and fat on the basis of the collected images. One-point Dixon method, two-point Dixon method, three-point and multi-point Dixon methods are simple and time-saving, however, they are very sensitive to motion artifacts, and the spin echo sequence is also very sensitive to motion artifacts. Therefore, there are often motion artifacts in the images obtained by the Dixon method, which is based on a Cartesian sampling trajectory.

In the radial or spiral trajectory method, the k-space data are entered in a non-Cartesian trajectory, such as a radial trajectory, or a spiral trajectory. On the basis of this sampling method, phase correction and chemical shift correction can be performed in the image domain and k-space so as to avoid blurred reconstructed images. The advantages of such methods are that motion introduces blurring rather than artifacts into the reconstructed images, which has relatively little influence on the identification of an object in the image; however, employing radial or spiral sampling trajectories usually would increase the computational complexity for reconstructing image and consume more time.

As mentioned above, the Cartesian trajectory method is simple and time-saving, but is very sensitive to motions such as the motion and pulsation of a rigid body. The radial or spiral trajectory method will convert motion artifacts to blurring in the reconstructed images; however, the calculation is complicated and the consumption of time is severe. In summary, neither of the above two types of methods can eliminate a rigid body's motion artifacts.

An imaging reconstruction method for water-fat separation is disclosed in Chinese patent application no. 200510008973.0 by the inventors Wang Jian-min and Weng De-he, and this method includes the following steps: (1) acquiring one in-phase image and two out-of-phase images; (2) calculating the sensitivity distribution of the data coils of the respective channels; (3) combining the images of respective channels; (4) calculating the phase difference between the two out-of-phase images; (5) detecting some characteristic regions in the in-phase image, to be used as a criterion for phase correction; and (6) correcting the phases of the out-of-phase images and calculating the images of water and fat.

### SUMMARY OF THE INVENTION

An object of the present invention is to provide a magnetic resonance imaging method for achieving water-fat separation so as to reduce the degree of sensitivity to motion artifacts in the imaging process.

This object is achieved in accordance with the present invention by a magnetic resonance imaging method for achieving water-fat separation that includes:

utilizing BLADE trajectories to acquire the original data of one in-phase image and the original data of two out-of-phase images;

reconstructing the in-phase image on the basis of the original data of the in-phase image, and utilizing the original data of the in-phase image to perform phase correction on the original data of the out-of-phase images, and reconstructing the out-of-phase images; and

calculating the images of water and fat on the basis of the in-phase image and out-of-phase images.

Preferably, the phase correction of the original data of the out-of-phase images includes: performing a two-dimensional fast Fourier transform on the data strip of the original data of the out-of-phase images; performing a window operation on the corresponding data strip of the original data of the in-phase image, and performing a two-dimensional fast Fourier transform thereon, so as to obtain the window data of the in-phase image; removing the phase of said window data of the in-phase image from the results of the original data of the out-of-phase images; and performing a two-dimensional inverse fast Fourier transform on the obtained data.

Furthermore, after having performed phase correction on the original data of the out-of-phase images, the rotation correction, translation correction and fast Fourier transform are performed thereon.

Preferably, the reconstruction of the in-phase image includes: performing phase correction, rotation correction, translation correction and fast Fourier transform on the original data of the in-phase image.

Preferably, the phase correction of the original data of the in-phase image includes: performing a window operation on the data strip of the original data of the in-phase image, and performing a two-dimensional fast Fourier transform thereon, so as to obtain a window data; performing a two-dimensional fast Fourier transform on the data strip, and removing the phase of said window data therefrom; and performing a two-dimensional inverse fast Fourier transform on the obtained data.

In an embodiment, the method first acquires two out-of-phase echoes, and then acquires one in-phase echo.

In another embodiment, the method first acquires one in-phase echo, and then acquires two out-of-phase echoes.

In another embodiment, the method first collects one out-of-phase echo, then acquires one in-phase echo, and then acquires another out-of-phase echo.

It can be seen from the above-mentioned solutions that since the present invention employs the BLADE trajectories to acquire the k-space data, it inherits the advantage that the BLADE trajectories are insensitive to the motion and pulsation of a rigid body, reduces the degree of sensitivity to motion artifacts and also improves the images' signal-to-noise ratio. Compared with the conventional reconstruction method by the BLADE trajectories, the present invention also makes advantageous use of the original data of the in-phase image to retain the information of the original data of the out-of-phase images, thus being able to achieve water-fat separation on the basis of the Dixon method.

### BRIEF DESCRIPTION OF THE DRAWINGS

FIG. 1 is a schematic flow chart of a method according to the present invention.

FIG. 2 is a schematic diagram of BLADE trajectories.

FIGS. 3A and 3B are schematic diagrams of the sequences, following which the three-point Dixon method is utilized to collect the original data of the out-of-phase images and the original data of the in-phase image.

FIG. 4A is a schematic flow chart of the present invention phase correction of the original data of the in-phase image. FIG. 4B is a schematic flow chart of the present invention for phase correction of the original data of the out-of-phase images.

FIGS. 5A, 5B and 5C are the out-of-phase image, in-phase image and out-of-phase image of a phantom, respectively, FIG. 5D is the water image of the phantom obtained according to the method of the present invention, and FIG. 5E is the fat image of the phantom obtained according to the method of the present invention.

FIGS. 6A, 6B and 6C are the out-of-phase image, in-phase image and out-of-phase image of a knee, respectively, FIG. 6D is the image of fat, and FIG. 6E is the image of water. FIG. 6F is the image of fat obtained according to the prior art.

FIGS. 7A, 7B and 7C are the out-of-phase image, in-phase image and out-of-phase image of a head, respectively, FIGS. 7D and 7E are images of fat, and FIGS. 7F and 7G are images of water. Among them, FIGS. 7D and 7F are images obtained according to the method of the present invention, and FIGS. 7E and 7G are images obtained by the Cartesian trajectory acquisition, rapid spin echo sequence and Dixon method.

### DESCRIPTION OF THE PREFERRED EMBODIMENTS

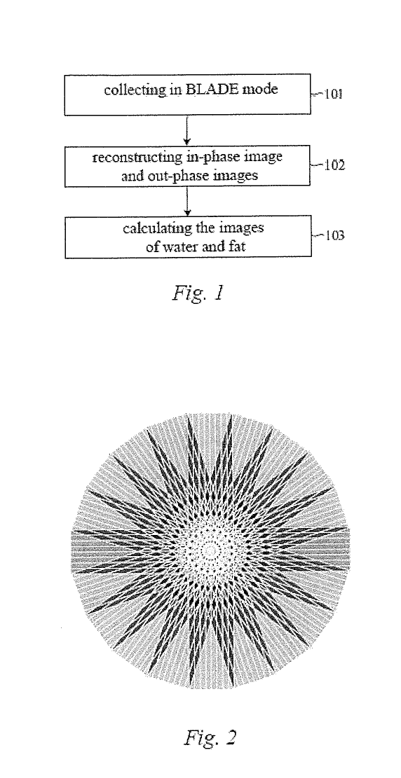

Referring to FIG. 1, according to an embodiment of the present invention, the magnetic resonance imaging method of the present invention for water-fat separation comprises the following steps:

Step 101, a magnetic resonance imaging device utilizes the blade artifact correction (BLADE) trajectories to acquire the original data of one in-phase image and the original data of two out-of-phase images.

The present invention is based on the application of the BLADE technology to the Dixon method. As to the BLADE technology, which is also referred to as PROPELLER (PROPELLER, Periodically Rotated Overlapping Parallel Lines with Enhanced Reconstruction) technology, reference can be made to the thesis by James G. Pipe “Motion Correction With PROPELLER MRI: Application to head motion and free-breathing cardiac imaging” (Magnetic Resonance in Medicine, 42: 963-969, November 1999).

The BLADE trajectories of the original data of each image are acquired (sampled) as shown in FIG. 2, the k-space data are acquired in N (N is a positive integer, and N is 10 in FIG. 1) data lines, and these data strips are distributed rotationally and equiangularly along the circumferential direction, with each data strip including L (L is a positive integer, and L is 9 in FIG. 1) rows of parallel data lines.

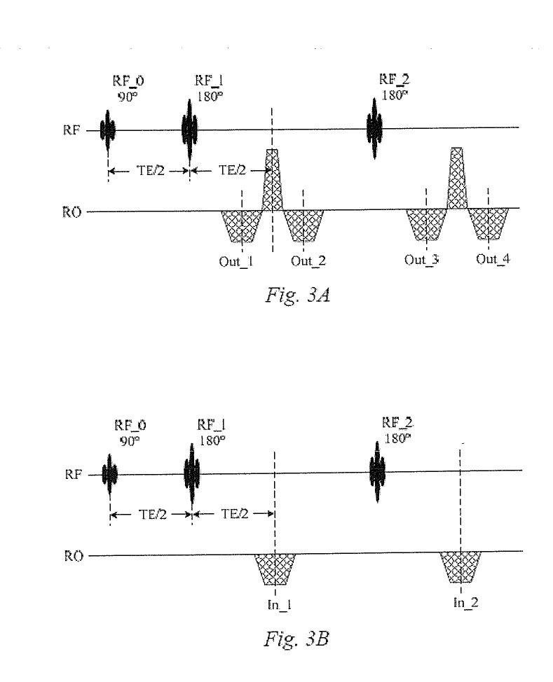

FIGS. 3A and 3B provide schematically the sequences which are used by the three-point Dixon method to collect each data strip in the BLADE trajectories, wherein the data acquired in FIG. 3A are the original data of the out-of-phase images and the data in FIG. 3B are the original data of the in-phase image. In FIGS. 3A and 3B, RF and RO represent radio frequency pulse and readout gradient, respectively, with slice selection gradient and phase encoding gradient omitted in the figures.

As shown in FIG. 3A, the magnetic resonance imaging device first transmits a 90 degree radio frequency pulse RF_0, and then transmits a 180 degree rephrasing radio frequency pulse RF_1. After the echo time (TE) from the 90 degree radio frequency pulse RF_0, the magnetic resonance imaging device applies a readout gradient in the direction of the readout gradient and reads out two data lines Out_1 and Out_2, respectively. Then, it transmits a 180 degree rephrasing radio frequency pulse RF_2, to obtain a second echo, and applies a readout gradient in the direction of the readout gradient, and reads out two data lines Out_3 and Out_4, respectively; the above-mentioned operations are repeated, until all the data lines in the BLADE trajectories are read out and the original data of two out-of-phase images are obtained. Among them, data lines Out_1, Out_3, Out_5 etc. constitute the original data of one out-of-phase image, and data lines Out_2, Out_4, Out_6 etc. constitute the original data of another out-of-phase image.

As shown in FIG. 3B, the magnetic resonance imaging device first transmits a 90 degree radio frequency pulse RF_0, and then transmits a 180 degree rephrasing radio frequency pulse RF_1. After the echo time (TE) from the 90 degree radio frequency pulse RF_0, the magnetic resonance imaging device applies a readout gradient in the direction of the readout gradient, and reads out a data line In_1. Then, it transmits a 180 degree rephrasing radio frequency pulse RF_2, obtains a second echo, applies a readout gradient in the direction of readout gradient, and reads out a data line In_2; the above-mentioned operations are repeated, until all the data lines in the BLADE trajectories are read out, and the original data of one in-phase image are obtained.

It needs to be explained that FIGS. 3A and 3B only provide schematically one collection order, and the present invention is not limited to this. For example, the present invention can first collect an in-phase echo, and then collects two out-of-phase echoes, so as to obtain the corresponding original data. Alternatively, one in-phase echo is collected between the collection of two out-of-phase echoes, and in this manner, three echoes are collected after each rephrasing pulse, i.e. one in-phase echo and two out-of-phase echoes, so as to obtain the corresponding original data.

Step 102, the magnetic resonance imaging device reconstructs the in-phase image on the basis of the original data of the in-phase image, and reconstructs the out-of-phase images on the basis of the original data of the out-of-phase images.

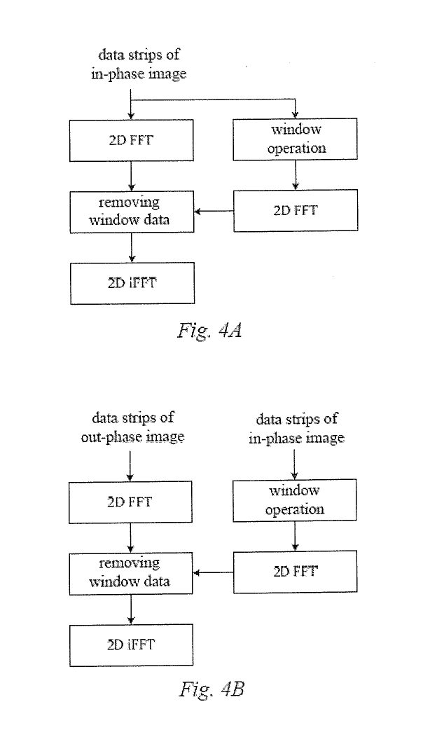

When reconstructing the in-phase image, the magnetic resonance imaging device first performs phase correction on each data strip. As shown in FIG. 4A, during the phase correction, a window function (such as triangle window function, pyramid window function) is utilized to perform a window operation on data strips and a two dimensional (2D) fast Fourier transform is performed on the data processed by the window operation, and for the sake of convenience the obtained data are referred to as the window data; on the other hand, a two dimensional fast Fourier transform is also performed on data strips, and the phase of the above-mentioned window data is removed therefrom, a two dimensional inverse fast Fourier transform (iFFT) is performed on the data obtained, so as to obtain the phase corrected data strips. Then, the magnetic resonance imaging device performs rotation correction and translation correction on the phase corrected data strips and obtains one in-phase image by a fast Fourier transform.

When reconstructing the out-of-phase images, the method according to the present invention provides improvements in the phase correction therein. As shown in FIG. 4B, during the phase correction, the magnetic resonance imaging device utilizes a window function to perform a window operation on corresponding data strips (equiangular data strips in k-space) of the original data of the in-phase image and performs a two-dimensional fast Fourier transform, so as to obtain the window data of the in-phase image; on the other hand, a two-dimensional fast Fourier transform is also performed on the data lines of the out-of-phase images, and the phase of window data of the above-mentioned in-phase image are removed therefrom, and a two-dimensional inverse fast Fourier transform is performed on the obtained data, so as to obtain the data lines of the phase corrected out-of-phase images. Similarly to the reconstruction process of the in-phase image, the rotation correction and translation correction are then performed on the phase corrected data lines, and finally the out-of-phase images are obtained by a fast Fourier transform.

During the above-mentioned process, a phase correction is performed on the data strips of the out-of-phase images by utilizing the data strips of the in-phase image as a reference, and this retains the out-of-phase information, thus the water-fat separation imaging can be performed on the basis of the Dixon method. During the conventional processing of the data acquired along the BLADE trajectories, since the out-of-phase information in the two out-of-phase images is eliminated, the out-of-phase images obtained by the conventional processes cannot be used for water-fat separation imaging in the Dixon method.

In step 103, the magnetic resonance imaging device calculates the image of water and the image of fat on the basis of one in-phase image and two out-of-phase images. In this step, various existing ways can be utilized to calculate the images of water and fat, such as in the Chinese patent application “a magnetic resonance imaging method for water-fat separation” by the applicant Siemens Mindit (Shenzhen) Magnetic Resonance Ltd., by the inventors He Qiang and Weng De-he filed on the same day as the present application, or the calculation method introduced in the Chinese patent application no. 200510008973.0, which need not be described herein.

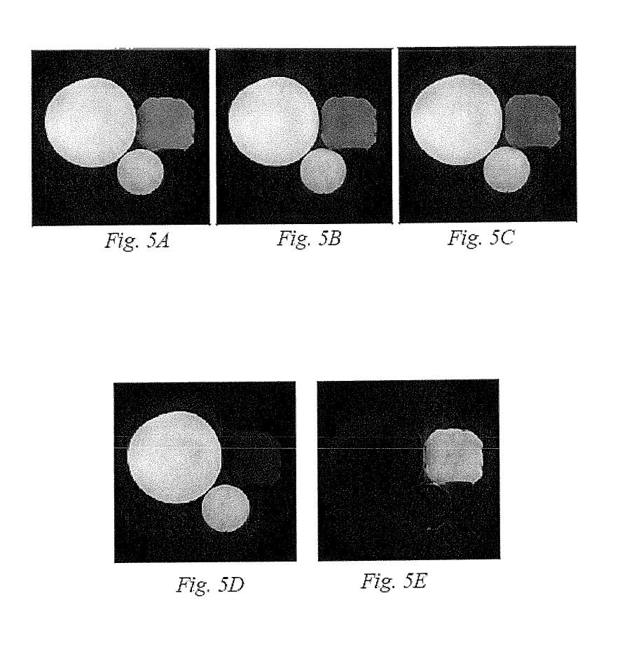

As shown in FIGS. 5A to 5E, the inventors of the present application have utilized a 1.5T magnetic resonance imaging device to perform water-fat separation imaging on a phantom on the basis of the method of the present invention. Two circular vessels used in the phantom were filled with water, and one square vessel was filled with edible oil (i.e. fat).

FIGS. 5A and 5C are the two out-of-phase images, respectively, FIG. 5B is the one in-phase image, FIG. 5D is the image of water obtained according to the method of the present invention, and FIG. 5E is the image of fat obtained according to the method of the present invention. It can be seen from the results of FIGS. 5D and 5E that the method of the present invention effectively separates water and fat in the images.

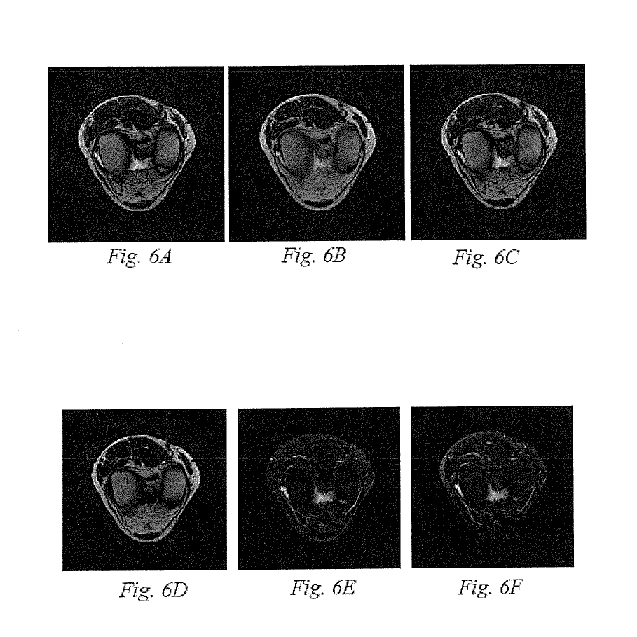

As shown in FIGS. 6A to 6E, the inventors of the present invention have also utilized the 1.5T magnetic resonance imaging device to perform water-fat separation imaging on a knee of a subject in accordance with the method of the present invention. FIGS. 6A and 6C are two out-of-phase images, respectively, FIG. 6B is one in-phase image, FIG. 6D is the image of water obtained according to the method of the present invention, and FIG. 6E is the image of fat obtained according to the method of the present invention. It can be seen from the results of FIGS. 6D and 6E that the method of the present invention effectively separates water and fat in the images.

For comparison, the method of frequency spectrum fat suppression was used to image the above-mentioned knee, and the result is as shown in FIG. 6F. It can be seen from the comparison of FIGS. 6E and 6F that FIG. 6E effectively separates water and fat and there is no apparent artifact: however, apparent pulse artifacts can be seen in the right and left direction of the human body (right and left directions in the image) in FIG. 6F.

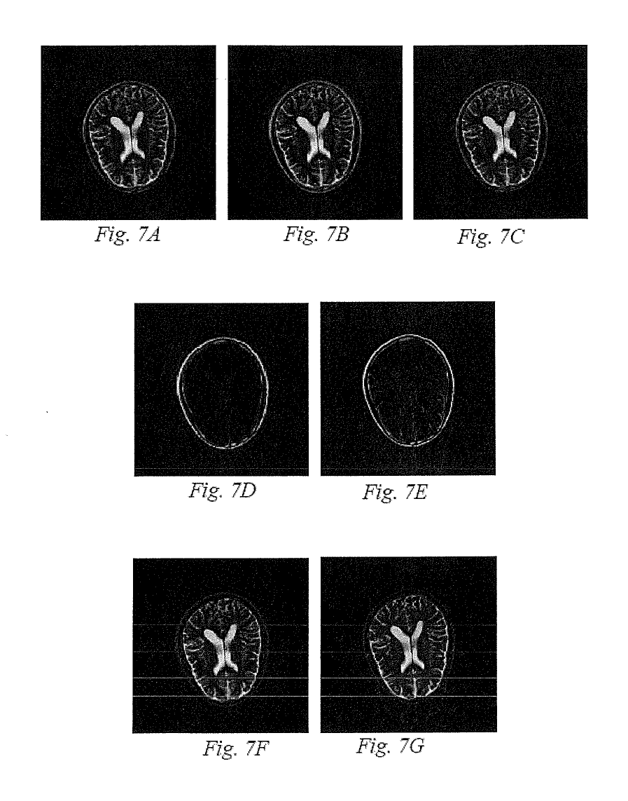

In addition, as shown in FIGS. 7A to 7G, the inventors of the present application have utilized the 1.5T magnetic resonance imaging device to perform water-fat separation imaging on the head of a subject according to the method of the present invention and another method (rapid spin echo sequence, Cartesian trajectory acquisition, and Dixon method water-fat separation technology). Among them, FIGS. 7A and 7C are two out-of-phase images, respectively, FIG. 7B is an in-phase image, FIG. 7D is the image of fat obtained according to the method of the present invention, FIG. 7E is the image of fat obtained according to the above-mentioned other method, FIG. 7F is the image of water obtained according to the method of the present invention, and FIG. 7G is the image of water obtained according to the above-mentioned another method.

It can be seen by comparing FIGS. 7D and 7E (the images of fat), and FIGS. 7F and 7G (the images of water), respectively, that the images of water and fat obtained according to the method of the present invention have fewer artifacts.

Although modifications and changes may be suggested by those skilled in the art, it is the intention of the inventor to embody within the patent warranted hereon all changes and modifications as reasonably and properly come within the scope of his contribution to the art.

I claim as my invention:

1. A magnetic resonance imaging method for achieving water-fat separation, the method comprising:
utilizing a BLADE artifact correction track to acquire the original data of one in-phase image and the original data of two out-of-phase images;
reconstructing the in-phase image on the basis of said original data of the in-phase image, and utilizing said original data of the in-phase image to perform phase correction on said original data of the out-of-phase images, and reconstructing the out-of-phase images; and
calculating images of water and fat on the basis of said in-phase image and said out-of-phase images.

2. The method according to claim 1, wherein the phase correction of the original data of the out-of-phase images comprises:
performing a two-dimensional fast Fourier transform on the data strip of the original data of the out-of-phase images;
performing a window operation on the corresponding data strip of the original data of the in-phase image and performing a two-dimensional fast Fourier transform, so as to obtain the window data of the in-phase image;
removing the phase of the window data of said in-phase image from the results of the original data of the out-of-phase images; and
performing a two-dimensional inverse fast Fourier transform on the obtained data.

3. The method according to claim 2, wherein, after having performed the phase correction on the original data of the out-of-phase images, the rotation correction, translation correction and fast Fourier transform are performed thereon.

4. The method according to claim 1, wherein the reconstruction of the in-phase image comprises: performing phase correction, rotation correction, translation correction and fast Fourier transform on the original data of the in-phase image.

5. The method according to claim 4, wherein the phase correction of the original data of the in-phase image comprises:
performing a window operation on the data strip of the original data of the in-phase image, and performing a two-dimensional fast Fourier transform thereon, so as to obtain a window data;
performing a two-dimensional fast Fourier transform on the data strip and removing the phase of said window data therefrom; and
performing a two-dimensional inverse fast Fourier transform on the obtained data.

6. The method according to claim 1, wherein the method first collects two out-of-phase echoes and then collects one in-phase echo.

7. The method according to claim 1, wherein the method first acquires one in-phase echo and then collects two out-of-phase echoes.

8. The method according to claim 1, wherein the method first acquires one out-of-phase echo, then collects one in-phase echo, and then collects another out-of-phase echo.
